(19) United States
(12) Patent Application Publication
(10) Pub. No.: US 2009/0260000 A1
(43) Pub. Date: Oct. 15, 2009

(54) METHOD, APPARATUS, AND MANUFACTURE FOR SOFTWARE DIFFERENCE COMPARISON

(75) Inventors: L. Mark Pilant, Litchfield, NH (US); Christopher J. Kordish, Tyngsboro, MA (US)

Correspondence Address: OSHA LIANG L.L.P./SUN, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 12/102,780

(22) Filed: Apr. 14, 2008

(51) Int. Cl. G06F 9/44

(52) U.S. Cl. 717/170

(57) ABSTRACT

A computer program for software difference comparison is provided. The program extracts data from the files on the hard disk, including data such as symbols extracted from symbol tables, APIs extracted from help files, and/or configuration information. This information may be collected at two or more different times, for example, before and after a version of software is updated to a new version of the software. The collected data is extracted into a relational database. The relational database may be used to determine the differences between multiple versions of software, or between one piece of software and another.

### FIELD OF THE INVENTION

The invention is related to computer software, and in particular but not exclusively, to a method, apparatus, and manufacture for determining differences in functionality in software between different version of software, or differences in functionality of a system with new software installed.

### BACKGROUND OF THE INVENTION

Most modern personal computers utilize an operating system to manage the resources of the computer and to provide an interface to those resources. Some well-known operating systems include the Windows family of operating systems, Linux, Mac OS X, GNU, BSD, and Solaris.

Some operating systems have updated versions. For example, Windows XP has Windows XP Service Pack 1, Service Pack 2, and Service Pack 3. In addition, an operating system may have several minor changes in between such service packs. For example, the application Windows Update updates the Windows operating system on a relatively regular basis, typically with several unofficial minor updates falling in between the major official Service Packs.

### BRIEF DESCRIPTION OF THE DRAWINGS

FIG. 1 shows a block diagram of an embodiment of a computer system;

FIG. 2 illustrates a flowchart of an embodiment of a process for software difference comparison;

FIG. 3 shows a flowchart of an embodiment of a process for extracting information including symbol information;

FIG. 4 shows a flowchart of an embodiment of a process for extracting information including Application Programming Interface (API) information from help files; and

FIG. 5 illustrates a flowchart of an embodiment of a process for extracting information including system configuration information, in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise.

Briefly stated, the invention is related to a computer program or set of computer programs for software difference comparison. The program(s) extracts data from the files on the hard disk, including data such as symbols extracted from symbol tables, APIs extracted from help files, and/or configuration information. This information may be collected at two or more different times, for example, before and after a version of software is updated to a new version of the software. The collected data is extracted into a relational database. The relational database may be used to determine the differences between multiple versions of software, or between one piece of software and another.

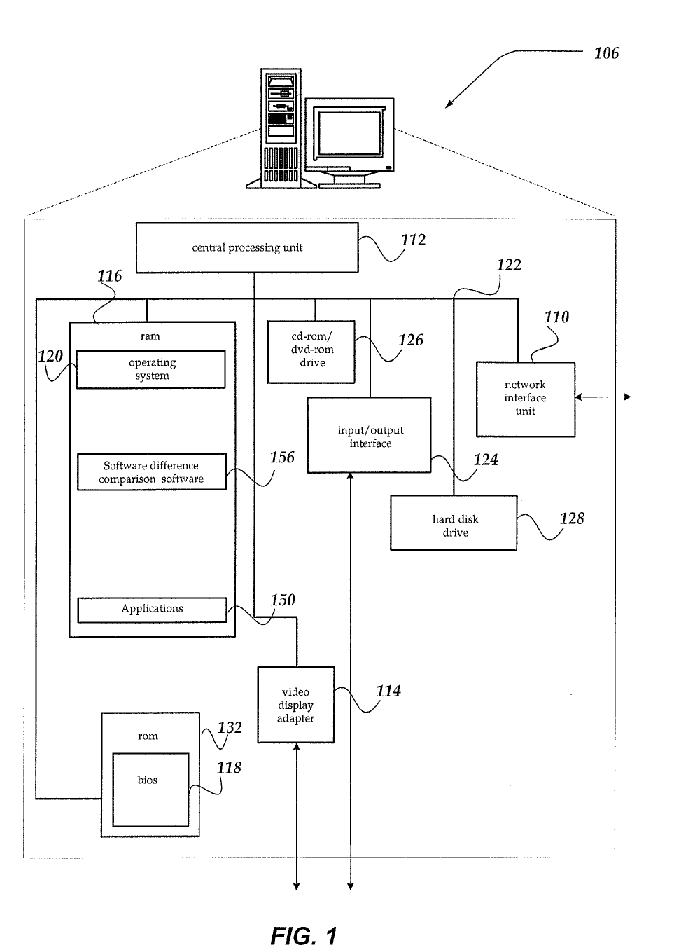

FIG. 1 shows a block diagram of an embodiment of computer system 106. Computer system 106 may include many more components than those shown. The components shown, however, are sufficient to disclose an illustrative embodiment for practicing the invention.

Computer system 106 may include processing unit 112, video display adapter 114, and a mass memory, all in communication with each other via bus 122. The mass memory generally includes RAM 116, ROM 132, and one or more permanent mass storage devices, such as hard disk drive 128, tape drive, optical drive, and/or floppy disk drive. The mass memory stores operating system 120 for controlling the operation of computer system 106. Any general-purpose operating system may be employed. Basic input/output system (“BIOS”) may also be provided for controlling the low-level operation of computer system 106. As illustrated in FIG. 1, computer system 106 also can communicate with the Internet, or some other communications network, via network interface unit 110, which is constructed for use with various communication protocols including the TCP/IP protocol. Network interface unit 110 is sometimes known as a transceiver, transceiving device, network interface card (NIC), and the like.

Computer system 106 also includes input/output interface 124 for communicating with external devices, such as a mouse, keyboard, scanner, or other input devices not shown in FIG. 1. Likewise, computer system 106 may further include additional mass storage facilities such as CD-ROM/DVD-ROM drive 126 and hard disk drive 128. Hard disk drive 128 is utilized by computer system 106 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 150 are loaded into mass memory and run on operating system 120. Examples of application programs include email programs, schedulers, calendars, transcoders, database programs, word processing programs, spreadsheet programs, and so forth. Mass storage may further include applications such as software difference comparison software 156.

Software difference comparison software 156 is a set of programs to collect, into a database, information about the software installed on computer system 106, such as operating system 120 and/or one or more or applications 150. Software difference comparison software 156 automates the comparison of different versions of software to determine how the software has changed, and what aspects of the software have changed. Additionally, in some embodiments, software difference comparison software 156 may be used not just to determine the difference between different versions of software, but to determine differences in computer system 106 caused by an installed application relative to the time prior to installation of the software.

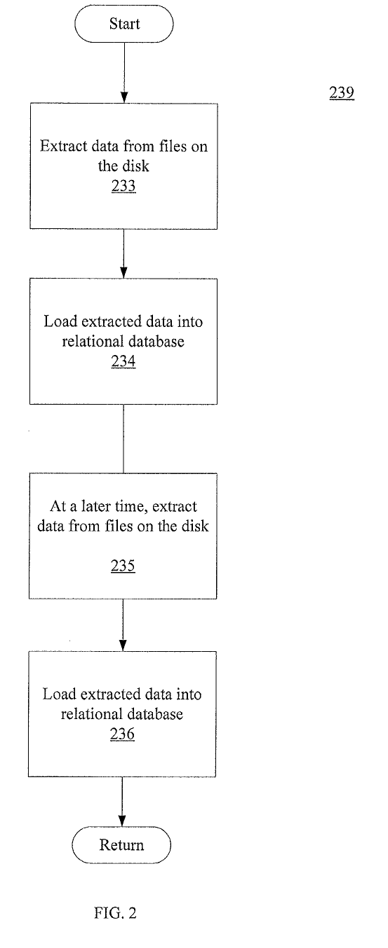

FIG. 2 illustrates a flowchart of an embodiment of process 239, which may be employed for software difference comparison.

After a start block, the process proceeds to block 233, where data is extracted from each of the files on the disk of the system (e.g. computer system 106 of FIG. 1). The data extracted by the step of block 233 includes one or more of symbols extracted from symbol tables, APIs extracted from help files, or configuration information.

The process than advances to block 234, where the extracted data is loaded into a relational database. The process then moves to block 235, where at a later time from the first extraction, data is again extracted from each of the files on the disk of the system. Next, the process proceeds to block 236, where the data extracted during the step of block 235 is loaded into the relational database. The process then advances to a return block, where other processing is resumed.

An API defines an inter-programming or intra-programming interface to a function. An API is defined by an operating system or library to provide an interface to respond to requests made by computer programs. APIs may be documented or undocumented. A function is a collection of computer instructions, with a well-defined start and finish, designed and implemented to perform a specific task.

A symbol identifies a function or an area of storage that is identified in a symbol table. A symbol table is a compile-time data structure that defines symbols by mapping symbol names onto attributes of the symbol such as type, scope, and/or location of the symbols.

### EMBODIMENT OF SYMBOL TABLE EXTRACTION

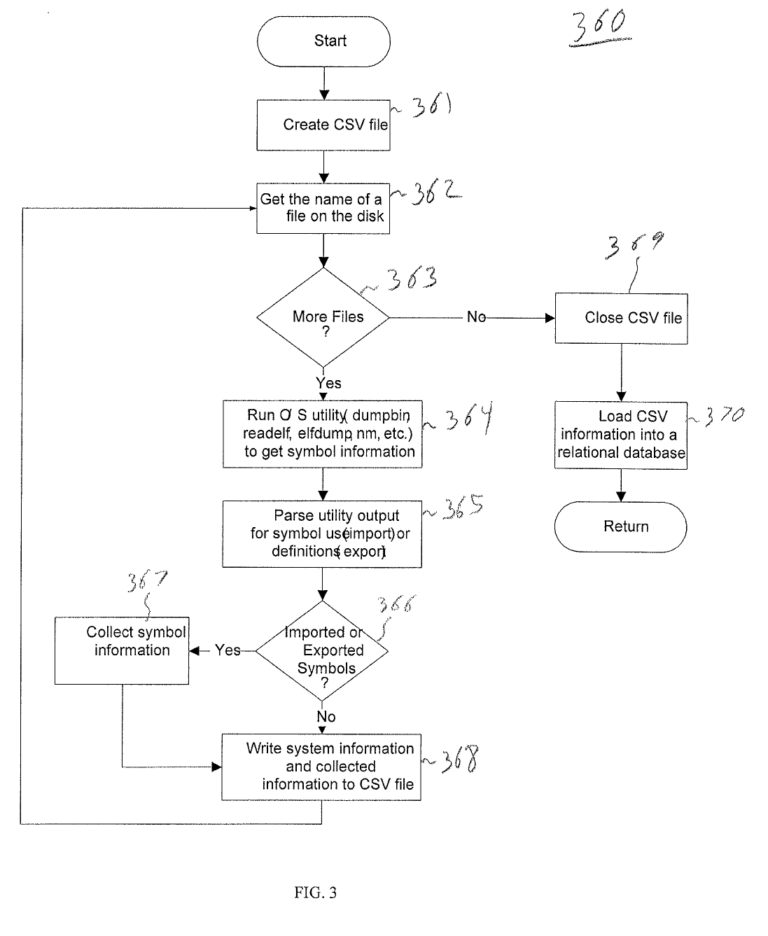

FIG. 3 shows a flowchart of an embodiment of process 360. Process 360 is an embodiment of a portion of process 239 for which symbol information is part or all of the extracted information.

After a start block, the process proceeds to block 361, where an empty .csv (comma separated variable) file is created. In other embodiments, other suitable types of files than .csv files may be employed. Alternatively, instead of creating a new CSV file, if difference information has already been extracted and added to a CSV, that CSV may be opened. The process then advances to block 362, where the name of a file on the disk is retrieved. More specifically, at block 362, the process retrieves the name of a file on the disk that has not been retrieved in a previous iteration of block 362, if any. In one embodiment, a utility is executed to get the name of every file present on the system drive.

The process then moves to decision block 363, where a determination is made as to whether there are more files to retrieve. The determination at decision block 363 is negative if symbol information has been extracted from all of the files on the disk. If the determination at decision block 363 is positive, the process proceeds to block 364, where an O/S (operating system) utility is run to retrieve symbol information from the file from which the name was retrieved at step 362. The symbol information is retrieved from symbol table(s) in the file, if there are any. For example, in one embodiment, a native system utility may be used, such as dumpbin.exe for Microsoft Windows, elfdump for UNIX, readelf for Linux, or the like. Alternatively, specifications are available which would allow a software developer to write a utility to generate the same information as the native system utility.

The process then advances to block 365, where the output of the O/S utility from block 364 is parsed for symbol use and/or definitions. Next, the process proceeds to decision block 366, where a determination is made as to whether the file includes any symbols, whether imported (used by the file) or exported (provided by the file).

If the determination at decision block 366 is positive, the process moves to block 367, where symbol information is collected. The process then moves to block 368, where the system information (information regarding computer system 106) and collected symbol information is written to the CSV file. Next, the process advances to decision block 362.

At decision block 366, if the determination is negative, the process proceeds to block 368.

At decision block 363, if the determination is negative, the process proceeds to block 369, where the CSV file is closed. The process then moves to block 370, where the CSV information is loaded into a relational database. Any suitable relational database may be used, such as Microsoft SQL server, postgreSQL, mySQL, Oracle, or the like. The process then advances to a return block, where other processing is resumed.

In some embodiments, every file on the present on the system drive is analyzed, since it is possible that symbols may in files with unexpected file types. Alternatively, in other embodiments, process 360 is performed only on selected types of files. In the normal case, functions providing functionality to a programmer (e.g., the printf( ) C run-time function) are supplied in a loadable library. On most Unix or similar systems such a file would have a .so file type. On Microsoft Windows, such a file would have a .dll, .exe, or .sys file type. However, one way to “hide” APIs is to place the function in a file with a non-standard file type. Analyzing all files allows all symbols to be found.

The symbols are usually executable images (import) and sharable libraries (import and export).

Gathering the raw symbol table information may be accomplished as follows in one embodiment. The software difference comparison software includes a utility program getfileinfo.exe in one embodiment. Each candidate file is processed by an operating system utility (e.g. dumpbin.exe for Microsoft Windows, elfdump for UNIX, readelf for Linux, etc.) and the output captured to a temporary file. This file is then processed by the getfileinfo.exe utility to extract the needed information.

The gathered information includes the name of the symbol, where available. In some cases, the name may be mangled. In some embodiments, the process attempts to de-mangle the name if it is mangled. (Symbol name mangling provides a way of encoding additional information about the name of a function, structure, class or another datatype in order to pass additional semantic information. De-mangling extracts the base name without the encoding.) In some cases, the symbol does not have a name, but may instead be identified by a symbol ordinal. The system ordinal is the numeric offset of the symbol which may be used instead of the actual name.

Each operating system utility produces a different format output file. However, as almost all the needed information is available, the basic logic used by the getfileinfo.exe utility remains unchanged. The only real differences are how the information is parsed; special symbols used to identify information, specific keywords or phrases, etc. Below are some annotated examples of the various output formats.

### Output File Examples

### Microsoft Windows

### dumpbin.exe

Shown below is a section of the output from the dumpbin.exe utility for the Kerberos.dll file showing the symbols defined in the file, and are exported for use:

Section contains the following exports for Kerberos.dll

| 00000000 | | | characteristics | |
|---|---|---|---|---|
| 42AF6F0A | | | time date stamp Tue Jun 14 19:58:02 2005 | |
| 0.00 | | | version | |
| 1 | | | ordinal base | |
| 32 | | | number of functions | |
| 10 | | | number of names | |
| | ordinal | hint | RVA | name |
| | 5 | 0 | 000268FA | KerbCreateTokenFromTicket |
| | 2 | 1 | 0002517B | KerbDomainChangeCallback |
| | 6 | 2 | 00001A20 | KerbFree |
| | 7 | 3 | 000204F5 | KerbIsInitialized |
| | 8 | 4 | 00020500 | KerbKdcCallBack |
| | 9 | 5 | 00003653 | KerbMakeKdcCall |
| | 1 | 6 | 00013A8D | SpInitialize |
| | 32 | 7 | 0000EBD8 | SpInstanceInit |
| | 3 | 8 | 00014FBE | SpLsaModeInitialize |
| | 4 | 9 | 0000EB17 | SpUserModeInitialize |

In the example above, the following information may be obtained:

| | |
|---|---|
| File name | Kerberos.dll |
| Link time and date: | Tue Jun 14 19:58:02 2005 |
| Image version: | 0.00 |
| Import/export type: | export |
| Symbol address: | 000268fa |
| Symbol name: | KerbCreateTokenFromTicket |
| Symbol ordinal | 5 |
| Symbol address: | 0002517b |
| Symbol name: | KerbDomainChangeCallback |
| Symbol ordinal | 2 |
| . . . | |

Shown below is a section of the output from the dumpbin.exe utility for the Kerberos.dll file showing some of the symbols needed and the file in which the needed symbols are defined:

Section contains the following imports:

ADVAPI32.dll

| 71CF1000 | Import Address Table |
|---|---|
| 71D30BE8 | Import Name Table |
| 0 | time date stamp |
| 0 | Index of first forwarder reference |
| 1D | AllocateAndInitializeSid |
| 148 | LookupAccountSidW |
| E1 | FreeSid |
| 1AF | OpenThreadToken |
| 23B | SetThreadToken |
| 6C | CredFree |
| 20C | RevertToSelf |
| 7C | CredUnmarshalCredentialW |
| 1E9 | RegQueryInfoKeyW |
| 1CC | RegConnectRegistryW |
| 200 | RegisterEventSourceW |
| 20B | ReportEventW |
| B0 | DeregisterEventSource |
| 88 | CryptCreateHash |
| 9D | CryptHashData |
| 99 | CryptGetHashParam |
| 8B | CryptDestroyHash |
| 86 | CryptAcquireContextW |

In the example above, the following information may be obtained:

| | |
|---|---|
| Import file name | ADVAPI32.dll |
| Import/export type: | import |
| Symbol name: | KerbCreateTokenFromTicket |
| Symbol name: | KerbDomainChangeCallback |
| . . . | |

UNIX—elfdump

Shown below is a section of the output from the elfdump utility (running on Solaris 10) for the /usr/lib/libcrypt.so file showing some of the symbols defined and needed:

Symbol Table Section: .dynsym

| index | value | size | type | bind | oth | ver | shndx | name |
|---|---|---|---|---|---|---|---|---|
| [0] | 0x00000000 | 0x00000000 | NOTY | LOCL | D | 0 | UNDEF | |
| [1] | 0x00000000 | 0x00000000 | FUNC | GLOB | D | 2 | ABS | crypt |
| [2] | 0x00000000 | 0x00000000 | FUNC | GLOB | D | 3 | ABS | _setkey |
| [3] | 0x00000000 | 0x00000000 | FUNC | GLOB | D | 3 | ABS | _crypt |
| [4] | 0x00000e00 | 0x0000003c | FUNC | GLOB | D | 3 | .text | _crypt_close |
| [5] | 0x000125e4 | 0x00000000 | OBJT | GLOB | D | 1 | .picdata | _edata |
| [6] | 0x00000a24 | 0x000000b8 | FUNC | GLOB | D | 3 | .text | _run_setkey |
| [7] | 0x00000000 | 0x00000000 | FUNC | GLOB | D | 0 | UNDEF | _thr_getspecific |
| [8] | 0x00000000 | 0x00000000 | FUNC | GLOB | D | 0 | UNDEF | _p2close |
| [9] | 0x00001404 | 0x00000274 | FUNC | GLOB | D | 3 | .text | _des_crypt |
| [10] | 0x00000000 | 0x00000000 | FUNC | GLOB | D | 0 | UNDEF | _mutex_lock |
| [11] | 0x00000000 | 0x00000000 | FUNC | GLOB | D | 0 | UNDEF | malloc |
| [12] | 0x00000000 | 0x00000000 | FUNC | GLOB | D | 0 | UNDEF | _mutex_unlock |
| [13] | 0x00000dac | 0x00000054 | FUNC | GLOB | D | 3 | .text | crypt_close_nolock |
| [14] | 0x00000e3c | 0x00000244 | FUNC | WEAK | D | 3 | .text | des_encrypt1 |
| [15] | 0x00000000 | 0x00000000 | FUNC | GLOB | D | 0 | UNDEF | _write |
| [16] | 0x00000000 | 0x00000000 | FUNC | GLOB | D | 2 | ABS | encrypt |
| [17] | 0x00000cb0 | 0x000000fc | FUNC | GLOB | D | 3 | .text | _makekey |

In the example above, the following information may be obtained:

| | |
|---|---|
| File name | libcrypto.so |
| Import/export type: | export |
| Symbol address: | 00000e00 |
| Symbol name: | _crypt_close |
| Symbol address: | 00000a24 |
| Symbol name: | _run_setkey |
| . . . | |
| Import/export type: | import |
| Symbol name: | _thr_getspecific |
| Symbol name: | _p2close |
| . . . | |

Shown below is a section of the output from the elfdump utility (running on Solaris 10) for the /usr/lib/libcrypt.so file showing some of the symbols used and the files in which the symbol is defined:

Syminfo Section: .SUNW_syminfo

| index | flgs | | bound to | symbol |
|---|---|---|---|---|
| [1] | F | [2] | libc.so.1 | crypt |
| [2] | F | [2] | libc.so.1 | _setkey |
| [3] | F | [2] | libc.so.1 | _crypt |
| [4] | D | | <self> | _crypt_close |
| [5] | N | | | _edata |
| [6] | D | | <self> | _run_setkey |
| [7] | D | [1] | libc.so.1 | _thr_getspecific |
| [8] | D | [0] | libgen.so.1 | _p2close |
| [9] | D | | <self> | _des_crypt |
| [10] | D | [1] | libc.so.1 | _mutex_lock |
| [11] | D | [1] | libc.so.1 | malloc |
| [12] | D | [1] | libc.so.1 | _mutex_unlock |
| [13] | D | | <self> | crypt_close_nolock |
| [14] | D | | <self> | des_encrypt1 |
| [15] | D | [1] | libc.so.1 | _write |
| [16] | F | [2] | libc.so.1 | encrypt |
| [17] | D | | <self> | _makekey |
| [18] | D | | <self> | _lib_version |
| [19] | D | [1] | libc.so.1 | signal |
| [20] | D | | <self> | _des_encrypt1 |

In the example above, the following information may be obtained:

| | |
|---|---|
| Import file name | libc.so.1 |
| Symbol name: | _thr_getspecific |
| Import file name | libgen.so.1 |
| Symbol name: | _p2close |
| . . . | |

getfileinfo.exe Utility Logic

As can be seen in the examples shown above, there is a great deal of commonality in the information available, regardless of the source (operating system).

The getfileinfo.exe utility logic, as a result of this commonality, is as follows in one embodiment:
1. Read a line from the dumpbin.exe/elfdump/readelf utility output until there are no more lines to be read.
2. Check for specific key words or phrases.
3. If no key word or phrase is found, go back to step 1.
4. If the key word or phrase is found, “remember” what type of information is expected. Key phrases identify general “sections” in the output. Some of these “sections” are:
   a. The header information.
   b. The exported symbol information.
   c. The imported information.
   d. The imported file and symbol information.
   e. Etc.
5. Based on the “section” parse the useful information (i.e., symbol name, address, etc.) until the next section is encountered.
6. Go to step 1.

### EMBODIMENT OF HELP FILE EXTRACTION

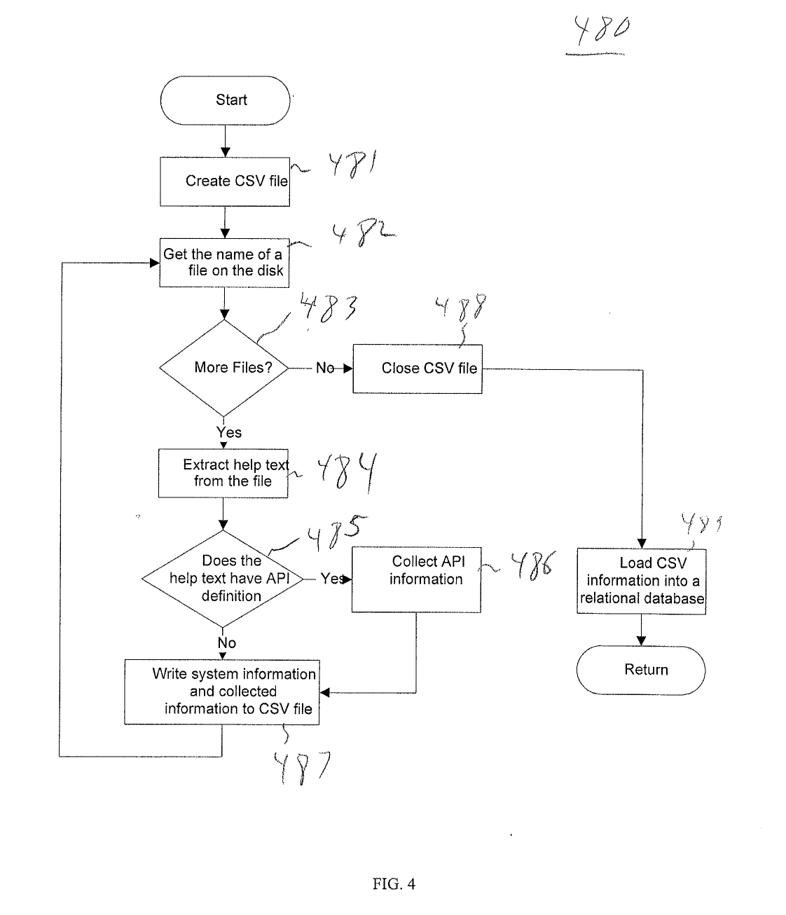

FIG. 4 shows a flowchart of an embodiment of process 480. Process 480 is an embodiment of a portion of process 239 for which API information from help files is part or all of the extracted information.

After a start block, the process proceeds to block 481, where a CSV file is created, or an existing CSV is opened. In other embodiments, other suitable types of files than CSV files may be employed. The process then advances to block 462, where the name of a file on the disk that is a help library (that has not been retrieved in a previous iteration of block 462, if any). In one embodiment, a utility is executed to get the name of every help file on the system drive.

The process then moves to decision block 463, where a determination is made as to whether there are help library files to retrieve. The determination at decision block 463 is negative if help text has been extracted from all of the files on the disk. If the determination at decision block 483 is positive, the process proceeds to block 484, where the help text is extracted from the file.

The process then moves to decision block 485, where a determination is made as to whether the help text includes API information. If so, the process moves to block 486, where the API information is collected. The process then advances to block 487, where the system information (information about computer system 106) and the collected API information are added to the CSV file. Next, the process moves to block 482.

At decision block 485, if the determination is negative, the process proceeds to block 487.

At decision block 463, if the determination is negative, the process proceeds to block 488, where the CSV file is closed. The process then moves to block 389, where the CSV information is loaded into a relational database. Any suitable relational database may be used, such as Microsoft SQL server, postgreSQL, mySQL, Oracle, or the like. The process then advances to a return block, where other processing is resumed.

In general, the help files are compressed libraries. In one embodiment, collecting the API information from compressed help libraries is accomplished as follows. In order to determine if an API is defined in the library, the library is uncompressed into plain text. This plain text is then parsed for specific key words and phrases which would indicate that an API definition is present. If an API definition is located, additional text is parsed to obtain the additional API information supplied. The entire help library is processed in this manner until no more API definitions are found.

### EMBODIMENT OF SYSTEM CONFIGURATION INFORMATION EXTRACTION

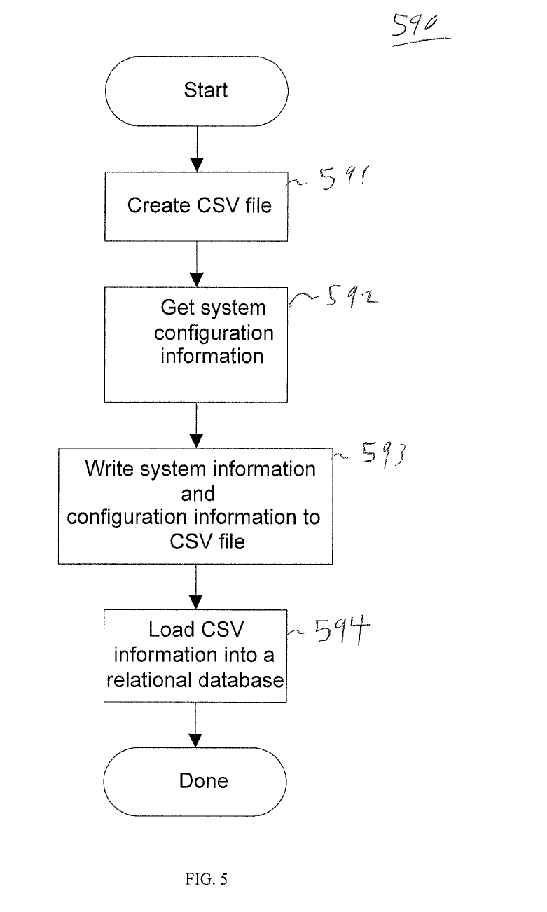

FIG. 5 shows a flowchart of an embodiment of process 590. Process 590 is an embodiment of a portion of process 239 for which system configuration information is part or all of the extracted information.

After a start block, the process proceeds to block 591, where a CSV file is created, or an existing CSV is opened. In other embodiments, other suitable types of files than CSV files may be employed. The process then advances to block 592, where system configuration information is retrieved from the disk.

The process then moves to block 593, where the system information (information regarding computer system 106) and collected system configuration information is written to the CSV file. Next, the process moves to block 594, where the CSV information is loaded into a relational database. Any suitable relational database may be used, such as Microsoft SQL server, postgreSQL, mySQL, Oracle, or the like. The process then advances to a return block, where other processing is resumed.

Getting the system configuration information is operating system specific. On Unix operating systems, some of the information may be gathered from various files; usually of the “.conf” file type. On Windows operating systems, the information is gathered from the Registry. This is done by dumping the contents of the registry and processing the results to identify all the registry keys and their associated values. The logic performed is as follows in one embodiment: look for a key definition and then parse the key name and value.

### EMBODIMENT OF CSV FILE FIELDS

In the embodiment described in this section, the CSV file contains several fields for each piece of information (symbol, API extracted from help file, or piece of system configuration information). One CSV file may be used for all of the information, or multiple CSV files may be used instead. Each piece of information includes several fields that include information about the system in which the file that contained the information resides. In one embodiment, the system information for each piece of information (e.g. symbol, API extracted from help file, or piece of system configuration information) is as follows:

| Information | Description |
|---|---|
| Processor architecture | The processor architecture (i.e., Intel, AMD, etc.) |
| Processor level | The processor level |
| Processor revision | The processor revision |
| Processor type | The type of processor (i.e., 386, 486, etc.) |
| OS name | The name of the operating system (i.e., Windows |
| | XP, Solaris 10, etc.) |
| OS additional info | Specifies any additional information needed to |
| | identify the operating system (e.g., service pack |
| | name) |
| OS build number | The specific build number |
| OS major version | The operating system's major version |
| OS minor version | The operating system's minor version |
| SP major version | The service pack's major version |
| SP minor version | The service packs minor version |

Additionally, in one embodiment, each symbol extracted from a symbol table includes the following fields in the CSV file. The symbols are usually executable images (import) and sharable libraries (import and export).

| Information | Description |
|---|---|
| File path | The path to the file whose information is being |
| | collected |
| File name | The name and type of the file whose information is |
| | being collected |
| File type | The type of the file whose information is being |
| | collected |
| File size | The size, in bytes, of the file. |
| Link time and date | The time at which the image or sharable library was |
| | linked |
| Image entry address | The file's entry address |
| Image base address | The file's base address |
| OS version | The operating system version on which the file was |
| | linked |
| Image version | The image version |
| Subsystem version | The subsystem version |
| Import file name | The name of the sharable image from which the |
| | symbol is to be loaded |
| Import/export type | Indicator defining whether the symbol is imported |
| | or exported |
| Symbol address | The address, in memory, of the symbol |
| Symbol name | The name of the symbol being imported or |
| | exported, or the keyword Ordinal |
| Symbol ordinal | The numeric offset of the symbol which may be |
| | used instead of the name |

In one embodiment, each documented API extracted from help files includes the following information in the CSV file:

| Information | Description |
|---|---|
| Library path | The full name of the library containing the help text |
| Help file name | The name of the file containing the API description |
| API type | The API type |
| API location | The name of sharable library containing the code |
| | supporting the API functionality |
| API name | The name of the API |

In one embodiment, each piece of configuration information also includes the following fields in the CSV file:

| Information | Description |
|---|---|
| Value path | The path to the piece of configuration information |
| Value name | The name associated with the configuration data |
| Value type | The type associated with the configuration data |
| Value data | The configuration data |

### EMBODIMENT OF SOFTWARE DIFFERENCE COMPARISON SOFTWARE USAGE

In one embodiment, the software difference comparison software (e.g. an embodiment of software difference comparison software 156) is utilized as follows. First, the user builds a system containing the desired software to be examined. If an operating system it to be examined, this is usually done by doing an installation of the operating system and/or service packs to a newly created and formatted disk partition. This is done to avoid any possible “contamination” which may occur as a result of an upgrade of an existing system. For example, upgrading from Windows 2000 to XP is possible, but there may be files left around which would not be present if a fresh install of Windows XP was done. However, it is also possible to investigate the non-fresh installations such as upgrading from Windows 2000 to Windows XP to see what files from Windows 2000 are left.

Second, for embodiments in which help files are to be examined for documented APIs and functions in the help files, the user identifies and loads the software containing the compressed help libraries. In one embodiment, for the most part, this will be the Operating System Platform Software Development Kit (SDK) and the Operating System Device Driver Driver Development Kit (DDK). These two contain the help for the majority of the “normal” APIs available to the software developer.

Next, the user loads the software difference comparison software onto the system in which the data collection is to occur. For example, this may be done by copying the necessary files to the system.

Next, the software difference comparison software performs data collection. Every file on the specified disk (containing the operating system and any desired application software) is examined to determine what information may be extracted. For example, this information may relate to symbols (identifying APIs/functions or data available to the programmer), documented APIs/functions, and configuration (e.g. registry) information. For example, the software difference comparison software may use process 360 of FIG. 3 to collect data related to symbols, process 480 of FIG. 4 to collect data related to documented APIs or functions, and process 590 of FIG. 5 to collect data related to system configuration information. In some embodiments, the software is capable of collecting information related to only one of these three areas (symbols extracted from symbol tables, APIs or functions extracted from help libraries, or configuration information). In other embodiments, the software is capable of collecting information for two or all three of these areas.

The data collection step is performed at multiple times, depending on the differences which are to be determined. For example, to determine the differences between an operating system before an upgrade and subsequent to the upgrade, the data collection may be performed on the system prior to the upgrade, and then performed after the upgrade. The data collection may also be done before and after a minor operating system changes, such as Unix updates or Windows updates. The differences of the system in two different states (based on different system configuration information) can be determined by collected data at the two different states, such as the first when it is first booted and the system when it is not booted.

In general, to compare differences between any two or more pieces of software, the data collection may be performed once with the system with each of the pieces of software installed on the system. To compare the difference caused on a system between with a particular piece of software installed on the system, the data collection may be performed both prior to installation of the software, and after installation of the software. The data may be collected multiple times on the same system with different configuration, on different systems having difference configurations, or both. In practice, generally the software difference comparison software will be run several times on systems of varying configurations.

After the data has been collected, the collected information may be loaded into a relational database in such a way as to allow the data to be quickly loaded and utilized for report generation. The collected data, which may be collected in a CSV file in some embodiments as previously discussed, serves as the raw information used for building the relational database. The data collected may be loaded into the database after each set of information has been gathered. Alternatively, the relational database may instead be created after all of the desired information has been collected.

After the relational database has been completed and all of the information pertinent to the desired collection or analysis has been loaded into the relational database, the software difference comparison circuit is ready to generate reports in response to user queries. The information in the relational database is mined to produce reports identifying various correlations and connections. The content of the reports are determined by the exact questions (queries) being asked about the data. The queries may be used to enable the user to identify various differences in software functionality (between two different version of software, between two difference pieces of software, or differences in functionality of the system prior to and after installing the software). For example, it may be used to determine the differences in software functionality in an operating system between the time prior to a minor unofficial update (such as a minor update on the Windows operating system performed by Windows update) being applied and the time subsequent to the minor unofficial update being applied.

### EMBODIMENT OF RELATIONAL DATABASE

In one embodiment, the format of the relational database of the software difference comparison software is a set of tables in a tree structure and a separate table containing the help file (API documentation) information. In this embodiment, the five tables containing the majority of the image data information are:
1. The processor information table containing the processor related information
2. The OS information table containing the OS related information.
3a. The path information table containing the path of each file.
4a. The file name table containing the file name and type of the file.
5a. The symbol table containing the symbol related information.
3b. The path information table containing the path of each piece of configuration information.
4b. The name table containing the name, type, and data for a specific piece of configuration information.

In one embodiment, each row of each table also contains a unique (identity) row id used as a primary key. This row id is also contained in the row information in the next lower table as a way to find the row in the parent table. This design allows redundant information to be eliminated saving considerable space in the database. However, it does this at the expense of having slightly more complicated database query statements.

In one embodiment, the help file information table is a flat table whose rows contain the information described above.

In one embodiment, the logic used in loading the collected data into the database is as follows:
1. A brute force check is made to insure all entries in the processor information are unique.
2. A “temporary” table is created whose rows represent each of the unique instances of operating system information in the bulk load table. This will usually only be one row.
3. The current identity value of the table being updated is obtained, the rows from the “temporary” table are inserted into the table being updated, and the current identity value is again obtained. The two identity values represent the range of identity values for the rows inserted.
4. Using the identity range, the rows are selected from the table and inserted into a new “subset” table. This is really the same as the “temporary” table, BUT, the rows contain the row id which was not available when the original insert was done. This “subset” table enables significant performance improvement. It represents only the distinct new rows inserted.
5. A “temporary” table is created whose rows represent each of the unique instances of path information and also matching the columns in the operating system “subset” table. Thus, rather than attempting to select from the entire relational database, only the “subset” table is used for selection.
6. Then the rows are inserted using the same identity trick described above, and a new “subset” path table is created.
7. And so on for the file table and symbol table.

### EMBODIMENT OF REPORT GENERATION

The reports generated are the result of analyses of the collected data, and may be produced relatively quickly due to the automated nature of their generation. Embodiments of some possible reports the software difference comparison software is capable of generating in response to queries as described below. One embodiment may perform all of the reports listed below, some embodiments may perform only some of the reports, and others may have reports that are different than those listed below in minor or major ways.

### Dependency List

This report shows all of the images needed to support specific application image. (a single application may have many images, all to support a specific piece of functionality.) This report can identify some of the expected dependencies but also unexpected dependencies. These unexpected dependencies can be an indication:

undocumented functionality,

changes in low level functionality (e.g., new protocol uses),

etc.

### File Differences

This report compares the information gathered from two instances of an operating system (usually two different versions) and identifies the files added or removed from one instance to the next. In the case of added files, this report helps direct further investigations by identifying the added files.

### File Version Differences

This report compares the information gathered from two instances of an operating system (usually two different versions) and identifies the files added or removed from one instance to the next. This report is slightly different than the one above (File Differences) in that the application link date and time are included in the comparison. This is very useful because it allows the detection of differences in a file which exists on both instances being compared.

### System Symbol Differences

This report compares the information gathered from two instances of an operating system (usually two different versions) and identifies the symbols (usually APIs or functions) added or removed from one instance to the next. Because the name of a symbol usually gives significant clues as to its purpose, this report can aid in determining added or removed functionality. In the case of added functionality, this report helps direct further investigations by identifying the files containing the new symbols.

### File Symbol Differences

This report compares the information gathered from two instances of a file (usually two different versions) and identifies the symbols (usually APIs or functions) added or removed from one instance to the next. Because the name of a symbol usually gives significant clues as to its purpose, this report can aid in determining added or removed functionality.

### Documented APIs

This report compares the symbols defined in a particular operating system instance with the APIs/functions documented for that same instance. The results identify whether or not any particular API/function has corresponding documentation.

### Undocumented APIs

This report identifies those APIs/function used in a particular operating system instance for which there is no corresponding documentation. This aids in directing the focus of further investigations.

### Dynamic Library Loading

This report uses the information gathered from a particular operating system instance to identify application images which enable functionality when the application is run. This is usually an indication of configuration-specific functionality, and the report results greatly help to direct further investigations.

### Hidden Symbols

This report lists identifies all the symbols existing in non-standard files. Symbols defined in this manner may be an attempt to hide the functionality associated with the symbol. For example, API/function for which no documentation exists.

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A method for software difference comparison, comprising:
extracting data from a plurality of files on a disk at a first time, wherein the extracted data includes at least one of: symbols extracted from symbol tables, application programming interfaces (APIs) extracted from help files, or configuration information;
loading the extracted data into a relational database;
extracting additional data from the plurality of files on the disk at a second time, wherein the extracted additional data includes at least one of: symbols extracted from symbol tables, APIs extracted from help files, or configuration information; and
loading the extracted additional data into the relational database.

2. The method of claim 1, wherein
the extracted data from the plurality of files on the disk at the first time includes symbols extracted from symbol tables, and further includes, for each extracted symbol name, the numeric offset of the symbol.

3. The method of claim 1, wherein
the extracted data from the plurality of files on the disk at the first time includes symbols extracted from symbol tables, and further includes, for each extracted symbol, an indicator that indicates whether the symbol is imported or exported.

4. The method of claim 1, further comprising:
using the relational database to determine differences in software functionality between the first time and the second time.

5. The method of claim 1, further comprising:
using the relational database to identify undocumented APIs.

6. The method of claim 1, wherein
the extracted data from the plurality of files on the disk at the first time includes symbols extracted from symbol tables, APIs extracted from help files, and configuration information.

7. The method of claim 1, wherein
the extracted data from the plurality of files on the disk at the first time includes APIs extracted form help files, and further includes, for each API extracted from the help files, the name of the API, and the API type.

8. The method of claim 1, wherein
the extracted data from the plurality of files on the disk at the first time includes configuration information, wherein the configuration information includes system registry information.

9. The method of claim 1, further comprising:
using the relational database to determine undocumented differences in functionality between: an operating system prior to a minor unofficial update, and subsequent to the minor unofficial update, wherein the first time is prior to the minor unofficial update, and the second time is subsequent to the minor unofficial update.

10. The method of claim 1, further comprising:
using the relational database to determine difference in symbols between: an operating system prior to a minor unofficial update, and subsequent to the minor unofficial update, wherein the first time is prior to the minor unofficial update, and the second time is subsequent to the minor unofficial update.

11. A processor-readable medium having processor-executable code stored therein, which when executed by one or more processors, enables actions, comprising:
extracting data from a plurality of files on a disk at a first time, wherein the extracted data includes at least one of: symbols extracted from symbol tables, application programming interfaces (APIs) extracted from help files, or configuration information;
loading the extracted data into a relational database;
extracting additional data from the plurality of files on the disk at a second time, wherein the extracted additional data includes at least one of: symbols extracted from symbol tables, APIs extracted from help files, or configuration information; and
loading the extracted additional data into the relational database.

12. The processor-readable medium of claim 11, wherein
the extracted data from the plurality of files on the disk at the first time includes symbols extracted from symbol tables, and further includes, for each extracted symbol, the numeric offset of the symbol.

13. The processor-readable medium of claim 11, wherein
the extracted data from the plurality of files on the disk at the first time includes symbols extracted from symbol tables, and further includes, for each extracted symbol, an indicator that indicates whether the symbol is imported or exported.

14. The processor-readable medium of claim 11, the processor-executable code enabling further actions, comprising:
using the relational database to determine differences in software functionality between the first time and the second time.

15. The processor-readable medium of claim 11, the processor-executable code enabling further actions, comprising:
using the relational database to identify undocumented APIs.

16. A device for software difference comparison, comprising:
a memory component for storing data; and
a processing component that is arranged to execute data that enables actions, including:
extracting data from a plurality of files on a disk at a first time, wherein the extracted data includes at least one of: symbols extracted from symbol tables, application programming interfaces (APIs) extracted from help files, or configuration information;
loading the extracted data into a relational database;
extracting additional data from the plurality of files on the disk at a second time, wherein the extracted additional data includes at least one of: symbols extracted from symbol tables, APIs extracted from help files, or configuration information; and
loading the extracted additional data into the relational database.

17. The device of claim 16, wherein processing component is arranged to execute the data to enable the actions such that:
the extracted data from the plurality of files on the disk at the first time includes symbols extracted from symbol tables, and further includes, for each extracted symbol, the numeric offset of the symbol.

18. The device of claim 16, wherein processing component is arranged to execute the data to enable the actions such that:
the processing component is arranged to execute the data to enable the actions such that the extracted data from the plurality of files on the disk at the first time includes symbols extracted from symbol tables, and further includes, for each extracted symbol, an indicator that indicates whether the symbol is imported or exported.

19. The device of claim 16, wherein the processing component is arranged to execute data to enable the actions, the actions further comprising:
using the relational database to determine differences in software functionality between the first time and the second time.

20. The device of claim 16, wherein the processing component is arranged to execute data to enable the actions, the actions further comprising:
using the relational database to identify undocumented APIs.
